(19) United States
(12) Patent Application Publication
(10) Pub. No.: US 2011/0153381 A1
(43) Pub. Date: Jun. 23, 2011

(54) Method and System for Smart Queuing of Test Requests

(76) Inventors: Saryu Shah, Watchung, NJ (US); Christian Kolmodin, Mountainside, NJ (US); Jackson Liu, Middletown, NJ (US); Daqin Liu, Morganville, NJ (US); Sanjeeta Mohapatra, Marlboro, NJ (US); Glenn Mohesky, Breese, IL (US); Timothy Plattner, Scotch Plains, NJ (US); Jason Tolbert, Garner, NC (US); Michael Zinnikas, North Brunswick, NJ (US)

(21) Appl. No.: 12/641,896

(22) Filed: Dec. 18, 2009

(51) Int. Cl. G06Q 10/00; G06N 5/02; G06F 11/07

(52) U.S. Cl. 705/7.22; 706/52; 705/304; 714/25; 714/E11.029; 705/7.26

(57) ABSTRACT

A system and method for receiving a service ticket, determining a likelihood of success of re-testing the service ticket and performing additional steps, if the likelihood of success is greater than a predetermined re-testing threshold. The additional steps including determining a waiting time of the service ticket, adding the service ticket to a service ticket queue containing a plurality of service tickets, the service ticket queue being sorted by a waiting time of each of the plurality of service tickets, initiating performance of the service ticket, after an expiration of the waiting time, removing the ticket from the queue, if the performance of the service ticket is successful and re-start the waiting time, if the performance of the service ticket is unsuccessful.

### BACKGROUND

During major or concentrated outages, network providers may typically handle a large number of service tickets. Automated execution of such tickets often fails due to the large volume of tickets. After retrying such tests several times, they are typically dropped out of automated processing and placed into a manual queue. This blind automatic re-testing leads to a waste of test resources when tests that are likely to be unsuccessful are retried in this manner.

### SUMMARY OF THE INVENTION

A computer readable storage medium storing a set of instructions executable by a processor. The set of instructions being operable to receive a service ticket, determine a likelihood of success of re-testing the service ticket, perform, additional steps if the likelihood of success is greater than a predetermined re-testing threshold. The additional steps including determining a waiting time of the service ticket, adding the service ticket to a service ticket queue containing a plurality of service tickets, the service ticket queue being sorted by a waiting time of each of the plurality of service tickets, initiating performance of the service ticket, after an expiration of the waiting time, removing the ticket from the queue, if the performance of the service ticket is successful and re-starting the waiting time, if the performance of the service ticket is unsuccessful.

A system including a memory and a processor. The system being configured to receive a service ticket, determine a likelihood of success of re-testing the service ticket, perform, if the likelihood of success is greater than a predetermined re-testing threshold, the steps of determining a waiting time of the service ticket, adding the service ticket to a service ticket queue containing a plurality of service tickets, the service ticket queue being sorted by a waiting time of each of the plurality of service tickets, initiating performance of the service ticket, after an expiration of the waiting time, removing the ticket from the queue, if the performance of the service ticket is successful and re-starting the waiting time, if the performance of the service ticket is unsuccessful.

### BRIEF DESCRIPTION OF THE DRAWINGS

FIG. 1 shows an exemplary system for performing the exemplary method of FIG. 2.

FIG. 2 shows an exemplary method for intelligently handling service tickets.

### DETAILED DESCRIPTION

The exemplary embodiments may be further understood with reference to the following description and the appended drawings, wherein like elements are referred to with the same reference numerals. The exemplary embodiments describe methods and systems for intelligently queuing and processing large numbers of service tickets.

During major or concentrated outages, such as may occur during natural disasters or severe weather events, network providers may typically handle a large number of service tickets. Automated execution of service tickets often fails due to the large volume of tickets. After retrying such tests several times, they are typically dropped out of automated processing and placed into a manual queue. This blind automatic re-testing leads to a waste of test resources when tests that are likely to be unsuccessful are retried in this manner.

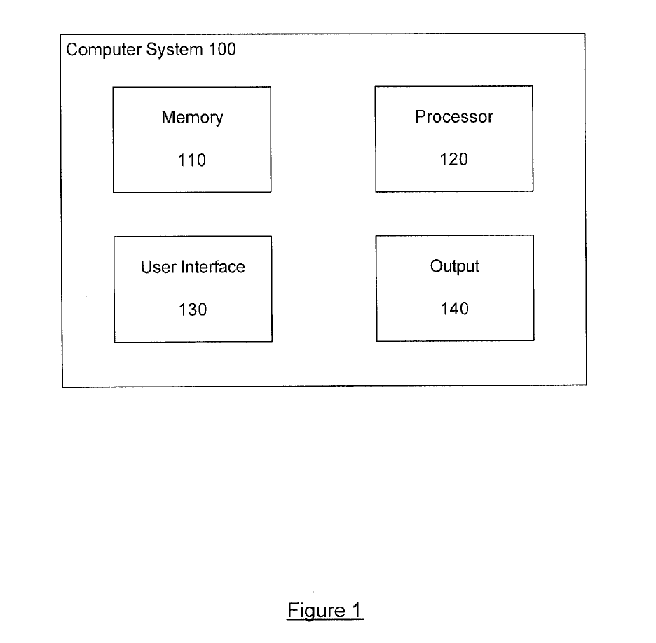

The exemplary embodiments present intelligent methods for queuing and processing service tickets. Tickets may be evaluated for a likelihood of success, prioritized, processed, and removed from the queue when appropriate. FIG. 1 illustrates a schematic view of an exemplary system 100 that may administer the operation of an exemplary intelligent queue. The system 100 may include a memory 110 that may store a program embodying the method 200, which will be discussed below. The memory 110 may be, for example, a hard drive, a CD-ROM storage, etc. The system 100 may further include a processor 120, a user interface 130, and an output 140. The processor 120 may be any of the various processors known in the art and suitable for performing the exemplary method 200. The user interface 130 may include a keyboard, a mouse, a touch-sensitive display, or any other mechanism by which a user may provide input. The output 140 may include a monitor, a printer, or any other mechanism by which results of the method 200 may be provided to a user.

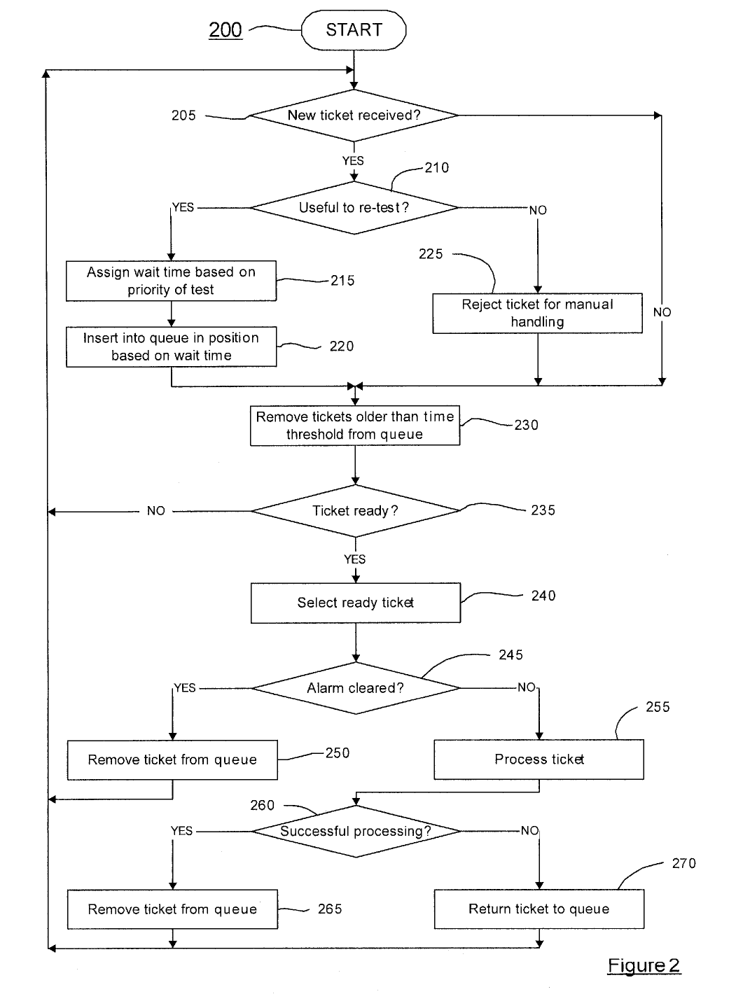

FIG. 2 illustrates an exemplary method 200 by which an intelligent queue may operate. In a preferred embodiment, the method 200 may operate continually while tickets are present in the queue; in other embodiments, it may be performed periodically, such as at a predetermined interval. For the purposes this description, it will be assumed that, at the beginning of the iteration of the method 200 to be described, a queue of tickets is already present; however, the method 200 may operate in a substantially similar manner in adding a first ticket to an empty queue. The service tickets handled by the exemplary method 200 may be any type of service ticket capable of being addressed both manually and automatically. In one preferred embodiment, they may be tickets relating to remote testing of individual customer circuits in a communications network.

In step 205, the processor 120 determines whether any new tickets have been received. If a new ticket has been received, in step 210 the processor 120 evaluates the new ticket to determine whether it would be useful to re-test the ticket. This determination is based on the likelihood of success if the ticket is re-tested. For example, a re-test may not be valuable if the processor 120 lacks some or all data required to conduct a successful re-test, if there are not enough testable points in the configuration, if a user has manually requested the test (thereby obviating the need to perform it automatically), or if there are multiple pending orders on the corresponding facility. Also within the scope of step 210, the processor 120 determines whether the new ticket should be linked to an element ticket, which is a ticket that tracks a higher-level network failure; if the ticket is so linked, it may be resolved by resolving the higher-level ticket, and thus is not added to the queue for repair on its own. If there is a likelihood of successful completion if the ticket is re-tested and the ticket is not linked to an element ticket, then in step 215 the processor 120 assigns a wait time based on the priority of the ticket. It will be apparent that a high-priority ticket may be assigned a short wait time, while a low-priority ticket may be assigned a longer wait time. In one exemplary embodiment, a default wait time may be 300 seconds, and other wait times may then be shortened or lengthened based on the priority of the ticket. This determination may be made by known processes, and the specific manner of doing so is beyond the scope of the exemplary embodiments.

Subsequently, in step 220, the processor 120 inserts the new ticket into the queue in a position that is appropriate to the wait time it has been assigned. Alternately, if, in step 210, it had been determined that re-testing the ticket would be unlikely to succeed, then in step 225 the ticket is rejected from the queue and output to a user (e.g., via output 140) for manual handling. Those of skill in the art will understand that while the above describes the process by which one received ticket may be added to the queue, the same steps may be used to handle multiple received tickets substantially simultaneously.

Once a new ticket or tickets has either been added to the queue in step 220, or rejected from the queue in step 225, the processor 120 proceeds to step 230. This step also follows if, in step 205, the processor 120 has determined that no new tickets have been received during the current performance of the method 200. In step 230, the processor 120 evaluates all tickets in the queue to determine how long each ticket has been in the queue, removes tickets that have been in the queue for longer than a predetermined time threshold, and outputs such tickets to a user for manual handling, as described above in step 225. In one embodiment, this time threshold may be 30 minutes.

Next, in step 235, the processor 120 determines whether the wait time of any tickets in the queue has expired, rendering such tickets ready for processing. If no tickets are ready for processing, the method returns to step 205. If a ticket is ready for processing, in step 240 that ticket is selected for processing. In step 245, the processor 120 initially determines whether the alarm resulting in the creation of the selected ticket has been resolved. If so, then in step 250, the processor 120 removes the selected ticket from the queue, and the method returns to step 105. If the alarm has not been cleared, then in step 255 the processor 120 initiates performance of the selected ticket. Processing may be accomplished by standard methods that are known in the art and beyond the scope of the exemplary embodiments. In some embodiments, the selected ticket may be executed by the system 100, while in others, it may be sent to an external system for processing.

In step 260, the processor 120 determines whether the ticket has been processed successfully. If processing was successful, then in step 265, the processor 120 removes the ticket from the queue; if not, then in step 270 the processor 120 returns the ticket to the queue and restarts its wait time. After step 265 or step 270, the method returns to step 205. While steps 240-270 describe the processing of a single ticket whose wait time has expired, those of skill in the art will understand that the same steps may be applied in the substantially simultaneous processing of multiple tickets whose wait times may expire substantially simultaneously.

The exemplary method 200 may thus separate service tickets for which automatic re-testing may be valuable, from service tickets for which it may not be. The exemplary method 200 may then administer the re-testing process in an optimal and orderly manner. As a result, resources used to re-test tickets may be conserved, while the overall process of re-testing large groups of tickets (e.g., to large-scale service outages) can be expedited, leading to faster restoration of service and an improved customer experience.

While the disclosure above specifically discusses the use of the exemplary embodiments during major outages that may typically lead to a large number of service tickets being active simultaneously, those of skill in the art will understand that the same principles are equally applicable to the processing of service tickets at other times. Further, it will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A computer readable storage medium storing a set of instructions executable by a processor, the set of instructions being operable to:
receive a service ticket;
determine a likelihood of success of re-testing the service ticket;
perform, if the likelihood of success is greater than a predetermined re-testing threshold, the steps of:
determine a waiting time of the service ticket;
add the service ticket to a service ticket queue containing a plurality of service tickets, the service ticket queue being sorted by a waiting time of each of the plurality of service tickets;
initiate performance of the service ticket, after an expiration of the waiting time;
remove the ticket from the queue, if the performance of the service ticket is successful; and
re-start the waiting time, if the performance of the service ticket is unsuccessful.

2. The computer readable storage medium of claim 1, wherein, if the likelihood of success is greater than the predetermined re-testing threshold, the instructions are further operable to:
remove the ticket from the queue, if a total time spent in the queue is greater than a predetermined expiration threshold.

3. The computer readable storage medium of claim 2, wherein the predetermined expiration threshold is 30 minutes.

4. The computer readable storage medium of claim 1, wherein the service ticket relates to a test of a component of a communications network.

5. The computer readable storage medium of claim 4, wherein the component is a customer circuit.

6. The computer readable storage medium of claim 1, wherein the instructions are further operable to:
determine if the service ticket corresponds to a higher-level ticket; and
perform, if the service ticket corresponds to the higher-level ticket, the steps of:
remove the service ticket from the queue; and
link the service ticket to the higher-level ticket.

7. The computer readable storage medium of claim 1, wherein the waiting time is determined based on a priority of the service ticket.

8. The computer readable storage medium of claim 1, wherein after the expiration of the waiting time and prior to performing the service ticket, the instructions are further operable to:
determine if an alarm corresponding to the service ticket has been cleared; and
remove the ticket from the queue, if the alarm has been cleared.

9. A system, including:
a memory; and
a processor configured to:
receive a service ticket;
determine a likelihood of success of re-testing the service ticket;
perform, if the likelihood of success is greater than a predetermined re-testing threshold, the steps of:
determine a waiting time of the service ticket;
add the service ticket to a service ticket queue containing a plurality of service tickets, the service ticket queue being sorted by a waiting time of each of the plurality of service tickets;
initiate performance of the service ticket, after an expiration of the waiting time;
remove the ticket from the queue, if the performance of the service ticket is successful; and
re-start the waiting time, if the performance of the service ticket is unsuccessful.

10. The system of claim 9, wherein, if the likelihood of success is greater than the predetermined re-testing threshold, the processor is further configured to:
remove the ticket from the queue, if a total time spent in the queue is greater than a predetermined expiration threshold.

11. The system of claim 10, wherein the predetermined expiration threshold is 30 minutes.

12. The system of claim 9, wherein the service ticket relates to a test of a component of a communications network.

13. The system of claim 12, wherein the component is a customer circuit.

14. The system of claim 9, wherein the processor is further configured:
determine if the service ticket corresponds to a higher-level ticket; and
perform, if the service ticket corresponds to the higher-level ticket, the steps of:
remove the service ticket from the queue; and
link the service ticket to the higher-level ticket.

15. The system of claim 9, wherein the waiting time is determined based on a priority of the service ticket.

16. The system of claim 9, wherein after the expiration of the waiting time and prior to performing the service ticket, the processor is further configured to:
determine if an alarm corresponding to the service ticket has been cleared; and
remove the ticket from the queue, if the alarm has been cleared.
